(19) United States
(12) Patent Application Publication
(10) Pub. No.: US 2019/0322480 A1
(43) Pub. Date: Oct. 24, 2019

(54) Device and method for aligning a flat material with respect to a laminating film

(71) Applicant: Chr. Renz GmbH, Heubach (DE)

(72) Inventor: Nicolas Herd, Nueringen (DE)

(21) Appl. No.: 15/959,890

(22) Filed: Apr. 23, 2018

(30) Foreign Application Priority Data
Apr. 23, 2018 (EP) 18 168 752.6

(51) Int. Cl. B65H 57/04; B65H 57/28; B65H 57/26

(52) U.S. Cl. CPC B65H 57/04; B32B 2037/0069; B65H 57/26; B65H 57/28

(57) ABSTRACT

A device for aligning a flat material in particular a paper sheet, with respect to a laminating film has the following features: a slot for the introduction of the laminating film with the flat material inserted therein, and an opposing force generating device for generating a force acting counter to the introduction direction (x) on the laminating film with the flat material inserted therein.

The invention relates to a device for aligning a flat material, in particular a paper sheet, with respect to a laminating film. Furthermore, the invention relates to a method for aligning a flat material, in particular a paper sheet, with respect to a laminating film.

Laminating films of this type and the procedure for laminating paper sheets are known from the general prior art. For this purpose, the paper sheet is inserted into a laminating film, which usually consists of two individual films connected to each other at one side edge. There is considerable difficulty, in particular for inexperienced users, in aligning the paper sheet within and with respect to the laminating film, which can lead to the paper sheet not being arranged exactly centrally in the laminating film. Frequently, therefore, the desired results are not achieved in such laminating processes. In any case, the alignment of the paper sheet with respect to the laminating film is associated with a great deal of effort, which frequently leads to such laminating processes having to be repeated.

It is therefore an object of the present invention to devise a device for aligning a flat material, in particular a paper sheet, with respect to a laminating film, which is simple to operate even for inexperienced users and leads to reliable results.

According to the invention, this object is achieved by the features recited in claim 1.

The device according to the invention has a slot for the introduction of the laminating film with the flat material inserted therein and an opposing force generating device, which generates a force acting counter to the introduction direction on the laminating film with the flat material inserted therein. In this way, during the introduction of the laminating film into the slot and during the subsequent insertion of the flat material into the laminating film and the application of a certain force to the flat material, the same is pushed into the slot together with the laminating film.

The opposing force generating device has the effect that the laminating film is moved through the slot only when the flat material is resting completely on the edge at which it comes into contact with the laminating film, and therefore parallel to the laminating film. As a result, during the introduction of the laminating film with the flat material inserted therein into the slot according to the invention, exact alignment of the flat material within the laminating film is achieved. The opposing force generating device therefore prevents the laminating film with the flat material inserted therein from simply sliding through the slot without any alignment of the flat material within the laminating film taking place.

The device according to the invention thus ensures very good and in particular constant results during the alignment of flat materials, in particular paper sheets, within laminating films. As a consequence, this leads to very exact working results if flat materials, in particular paper sheets, are to be laminated.

In a very advantageous development of the invention, provision can be made for the slot to be formed by two guide elements spaced apart from each other. These guide elements, which guide the laminating film with the flat material inserted therein during the alignment, constitute a simple possible way of forming the slot. The guide elements can both be components that are independent of each other and also a one-piece component into which the slot is introduced.

An embodiment of the invention that can be implemented very simply can consist in the opposing force generating device having one or more frictional elements projecting into the slot, which consist of an elastic material or are elastically mounted. Such frictional elements consisting of an elastic material, for example rubber strips or rubber lips, ensure in a particularly reliable way that the opposing force required for the exact alignment of the flat material with respect to the laminating film is generated. The frictional elements can also be implemented as cams or the like, which are mounted elastically, for example resiliently, and in this way form the opposing force generating device.

If the at least one frictional element is fixed by means of at least one fixing element to one of the guide elements forming the slot, the result is a simple construction which ensures secure retention of the frictional elements on one of the guide elements. In principle, however, it would also be possible to hold the at least one frictional element without or else with multiple small fixing elements. For example, the at least one frictional element could be designed to be adhesively bonded to at least one of the guide elements or designed in one piece with the same. What is important is only the generation of a slight resistance, which aligns the flat material with the edge of the laminating film.

In a very advantageous development of the invention, provision can be made for the opposing force generating device to have at least one brush projecting into the slot. Such a brush can have the aforementioned frictional elements, consisting of an elastic material, in the form of individual bristles and is likewise capable of generating the requisite opposing force counter to the introduction direction of the laminating film.

A further advantageous refinement of the invention can consist in the opposing force generating device having at least two rotatable rollers and/or rolls formed as guide elements forming the slot. Such rollers or rolls can likewise generate the desired opposing force by generating friction on the laminating film led through the same. Here, the statement “rollers and/or rolls” means all types of rotatable elements with which the desired opposing force can be generated. If appropriate, these rotatable elements can also be driven.

A very simple possible way of forming the opposing force generating device can additionally consist in said device being formed by a friction-increasing layer on at least one of the guide elements forming the slot. Although exact implementation of the guide elements forming the slot between them is necessary, the result is advantageously little outlay and in particular no additional parts.

This is also the case if the opposing force generating device is formed by the guide elements forming the slot being at a distance from each other such that, within the slot, a force acting counter to the introduction direction is generated on the laminating film with the flat material inserted therein. In principle, it is specifically possible to dispense with additional components and merely to align the guide elements very exactly with each other or to arrange the same very exactly relative to one another, so that the effect of the generation of an opposing force counter to the introduction direction of the laminating film in the slot is likewise generated. However, it is possible that such a solution is suitable only for specific thicknesses of the laminating film and flat materials inserted therein.

A further very advantageous embodiment of the invention can consist in that at least one stop for the laminating film is arranged on at least one marginal edge of the slot. As a result, exact alignment of the laminating film in the longitudinal direction of the slot is ensured.

This can be used particularly advantageously when at least one stop for the flat material is arranged on at least one marginal edge of the slot. In this way, a stop is also provided for the flat material inserted into the laminating film.

Very exact alignment of the flat material within the laminating film results if the at least one stop for the flat material is at a distance from the at least one stop for the laminating film which corresponds to a lateral projection that is to be formed of the laminating film beyond the flat material. This projection can accordingly be set in accordance with the distance by which the stop for the flat material projects beyond the stop for the laminating film. If appropriate, at least one of the stops could also be designed to be adjustable.

Furthermore, provision can be made for a support surface to adjoin at least one of the guide elements forming the slot. This represents a simplification of the operation of the device according to the invention, since the user can lay part of the laminating film down on the support surface.

In order to simplify the fabrication of the device according to the invention, provision can also be made for the support surface to be formed in one piece with the guide element.

A method for aligning a flat material, in particular a paper sheet, with respect to a laminating film by means of a device according to the invention is specified in claim 14.

This method permits very simple alignment of the flat material with respect to the laminating film, so that the desired working results are reliably achieved.

An embodiment of the method that is particularly easily comprehensible for ail users results if the laminating film with the flat material inserted therein is drawn through the slot.

### BRIEF DESCRIPTIONS OF THE FIGURES

An exemplary embodiment of the invention is illustrated below in principle by using the drawing, in which:

FIG. 1 shows a perspective view of a device according to the invention;

FIG. 2 shows a section along the line lull from FIG. 1;

FIG. 3 shows a first state during the performance of a method according to the invention;

FIG. 4 shows a second state during the performance of the method according to the invention; and

FIG. 5 shows a third state during the performance of the method according to the invention.

### DETAILED DESCRIPTION OF THE EMBODIMENTS

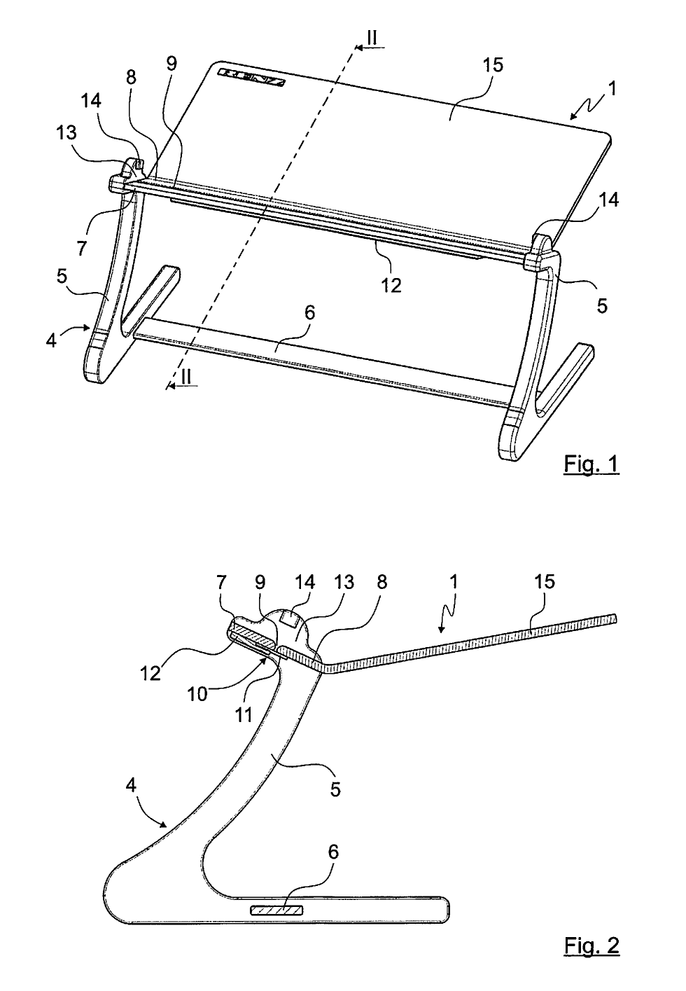

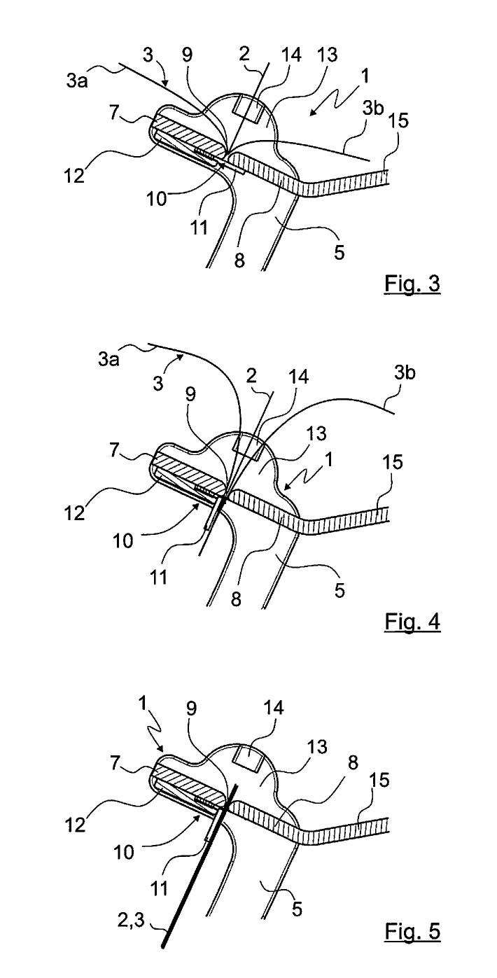

FIG. 1 shows a device 1 for aligning a flat material 2, in the present case a paper sheet 2a, with respect to a laminating film 3. The device 1 has a frame 4 having two feet 5 spaced apart from each other and a connecting element 6 connecting the two feet 5 to each other. In the upper region of the feet 5, said feet are connected to each other by means of two guide elements 7 and 8. The two guide elements 7 and 8, which can also be designated as webs, form between them a slot 9, which can be seen better in the section of FIG. 2. The slot 9 is used for the introduction of the laminating film 3 with the flat material 2 inserted therein, as can be seen better in FIGS. 3, 4 and 5. To this end, the slot 9 has a suitable width in order to be able to accommodate paper sheets 2a and laminating films 3 matched thereto with desired formats.

Furthermore, the device 1 has an opposing force generating device 10, which is used to generate a force, acting counter to the introduction direction of the laminating film 3, designated by “x” in FIGS. 3 to 5, with the flat material 2 inserted therein into the slot 9, onto the laminating film 3 with the flat material 2 inserted therein.

In the exemplary embodiment illustrated in the figures, the opposing force generating device 10 has one or more frictional elements 11 arranged along the slot 9 and projecting into the slot 9, which consist of an elastic material, such as rubber. The frictional elements 11 in the present case are fixed to one of the guide elements 7 or 8 forming the slot 9, in the present case to the front guide element 7, by means of a fixing element 12 which is formed in the manner of a strip.

Furthermore, the device 1 has a first stop 13 which is arranged on a marginal edge of the slot 9 and which is used to locate the laminating film 3. In the present case, the first stop 13 for the laminating film 3 is formed by the region of the foot 5 that is located above the guide elements 7 and 8. The device 1 additionally has a second stop 14, which is used to locate the flat material 2 as the latter is aligned with respect to the laminating film 3. The stop 14 is likewise provided on the foot 5, to be specific above the first stop 13, and extends away from the foot 5 in the direction of the slot 9. Preferably, the second stop 14 for the flat material 2 is at a distance from the first stop 13 for the laminating film 3 which corresponds to a lateral projection of the laminating film 3 over the flat material 2 that is to be formed. As a result, the exactly desired spacing of the marginal edge of the flat material 2 from the marginal edge of the laminating film 3 is set. It is also possible to see that respective stops 13 and 14 are provided on both sides of the slot 9 and at both ends of the same. Additionally or alternatively to the stops 13 and/or 14, it is also possible to apply a mark, which may possibly be colored, at a suitable point of the device 1, on which mark the laminating film 3 and the flat material 2 could be aligned. Since the laminating film 3 is transparent, such a colored mark would be seen easily. In addition, tangible or elevated marks, which project beyond the surface to which they are applied, are conceivable.

One of the guide elements 7 or 8 forming the slot 9, in the present case the rear guide element 8, is adjoined by a support surface 15, which is used to locate the laminating film 3 during the alignment of the flat material 2 with respect to the laminating film 3. The support surface 15 in the exemplary embodiment illustrated is formed in one piece with the guide element 8.

Preferably, all the components of the device 1 with the exception of the frictional elements 11 are formed from plastic and, for example, can be produced in an injection molding process. For example, the connecting element 6 and the guide elements 7 and 8 can be connected to the feet 5 by means of suitable plug-in connections. In addition, these parts can also be screwed and/or adhesively bonded to each other.

In FIGS. 3 to 5, a method for aligning the flat material 2 or the paper sheet 2a with respect to the laminating film 3 by means of the above-described device 1 is illustrated. Firstly, the laminating film 3 is placed on the slot 9 and the flat material 2 is inserted into the opened laminating film 3, as illustrated in FIG. 3. The laminating film 3 is formed in a manner known per se from two individual laminating films 3a and 3b, which are connected to each other at one of their short side edges, in particular welded, and which are spread apart in order to introduce the flat material 2 between them. The laminating film 3 and the flat material 2 inserted into the laminating film 3 are then introduced into the slot 9, and a force is applied to the flat material 2 in the direction of the laminating film 3, that is to say in the introduction direction designated by “x” in FIGS. 3 to 5. This force leads to the flat material 2 being aligned at its lower edge, touching the laminating film 3, with the laminating film 3, since the opposing force generating device 10 is designed in such a way that, when such a force is applied, it applies an opposing force to the laminating film 3 and prevents or impedes the penetration of the same into the slot 9. Only when a higher force is applied or when the flat material 2 has been introduced completely into the laminating film 3 is the opposing force generating device 10, in the present case therefore the frictional elements 11, forced away downward, as illustrated in FIG. 4. This leads to the laminating film 3 with the flat material 2 inserted therein moving through the slot 9. The laminating film 3 with the flat material 2 inserted therein can then be drawn through the slot 9. However, this is not absolutely necessary, since the alignment operation has already taken place previously, and it is also possible to draw the laminating film 3 with the flat material 2 inserted therein out of the slot 9, counter to the direction “x”. The laminating film 3 with the flat material 2 inserted therein can then be laminated in a manner known per se.

While, in the embodiment illustrated in the figures, the opposing force generating device 10 has a plurality of frictional elements 11 arranged along the slot 9 and projecting into the slot 9, it can also be formed differently. For example, it is possible for the opposing force generating device 10 to have at least two rotatably mounted rollers or rolls, between which the slot 9 is formed. In other words, the rollers or rolls would in this case represent the guide elements 7 and 8 forming the slot 9. The opposing force generating device 10 can also be formed by a friction-increasing layer on at least one of the guide elements 7 and/or 8 forming the slot 9. Furthermore, there is the possibility of forming the opposing force generating device 10 by the guide elements 7 and 8 forming the slot 9 being at a distance from each other such that, within the slot 9, a force acting counter to the introduction direction x is generated on the laminating film 3 with the flat material 2 inserted therein. This distance can amount approximately to the thickness of the laminating film 3 and a flat material 2 inserted therein plus a certain allowance. In addition, it would be possible to form the opposing force generating device 10 in the form of a deflection device or cascade. A further possible way of implementing the opposing force generating device 10 consists in using cams that can be rotated by less than 360 and spring back. All of the aforementioned embodiments of the opposing force generating device 10 can also be combined with one another.

The opposing force generating device 10 can also be implemented by other embodiments, not described herein. What is critical here is merely that the opposing force generating device 10 generates a force, acting counter to the introduction direction x of the flat material 2 aligned with the laminating film 3, on the laminating film 3 with the flat material 2 inserted therein, since in this way the laminating film 3 moves through the slot 9 only when the flat material 2 is resting completely on and parallel to the laminating film 3, and thus the flat material 2 is aligned exactly within the laminating film 3.

1. A device for aligning a flat material, in particular a paper sheet, with respect to a laminating film comprising:
a slot for the introduction of the laminating film with the flat material inserted therein; and
an opposing force generating device for generating a force acting counter to an introduction direction (x) on the laminating film with the flat material inserted therein.

2. The device according to claim 1, and wherein the slot is formed by two guide elements spaced apart from each other.

3. The device according to claim 1, and wherein the opposing force generating device has at least one frictional element projecting into the slot, which consist of an elastic material or are elastically mounted.

4. The device according to claim 3, and wherein the at least one frictional element is fixed by means of at least one fixing element to one of the guide elements forming the slot.

5. The device according to claim 1, and wherein the opposing force generating device has at least one brush projecting into the slot.

6. The device according to claim 2, and wherein the opposing force generating device has at least two rotatable rollers and/or rolls formed as the guide elements forming the slot.

7. The device according to claim 2, and wherein the opposing force generating device is formed by a friction-increasing layer on at least one of the guide elements forming the slot.

8. The device according to claim 2, and wherein the opposing force generating device is formed by the guide elements forming the slot being at a distance from each other such that, within the slot, a force acting counter to the introduction direction is generated on the laminating film with the flat material inserted therein.

9. The device according to claim 1, and wherein at least one stop for the laminating film is arranged on at least one marginal edge of the slot.

10. The device according to claim 1, and wherein at least one stop for the flat material is arranged on at least one marginal edge of the slot.

11. The device according to claim 9, and wherein the at least one stop for the flat material is at a distance from the at least one stop for the laminating film which corresponds to a lateral projection that is to be formed of the laminating film beyond the flat material.

12. The device according to claim 2, and wherein a support surface adjoins at least one of the guide elements forming the slot.

13. The device according to claim 12, and wherein the support surface is formed in one piece with the guide element.

14. A method for aligning a flat material, in particular a paper sheet, with respect to a laminating film by means of a device according to claim 1, wherein the laminating film and the flat material (2) inserted into the laminating film are introduced into the slot, and wherein a force is applied to the flat material in the direction of the laminating film.

15. The method according to claim 14, and wherein the laminating film with the flat material inserted therein is drawn through the slot.

16. The device according to claim 10, and wherein the at least one stop for the flat material is at a distance from the at least one stop for the laminating film which corresponds to a lateral projection that is to be formed of the laminating film beyond the flat material.
